(19) United States
(12) Patent Application Publication
(10) Pub. No.: US 2024/0391767 A1
(43) Pub. Date: Nov. 28, 2024

(54) CONDITIONS FOR AQUEOUS PHASE REFORMING

(71) Applicant: VIRENT, INC., Madison, WI (US)

(72) Inventor: Colin Anson, Madison, WI (US)

(21) Appl. No.: 18/670,672

(22) Filed: May 21, 2024

Related U.S. Application Data
(60) Provisional application No. 63/504,135, filed on May 24, 2023.

(51) Int. Cl. C01B 3/32

(52) U.S. Cl. CPC C01B 3/326; C01B 2203/0233; C01B 2203/107; C01B 2203/1082; C01B 2203/1217; C01B 2203/1623

(57) ABSTRACT

The present disclosure provides a method for producing hydrogen in an aqueous phase reforming process using a water-soluble oxygenated hydrocarbon under improved conditions. The present method can be used to produce hydrogen from glycerol at reduced pressure and significantly increased hydrogen yield.

### CROSS-REFERENCE TO RELATED APPLICATIONS

This application claims priority to U.S. Provisional patent application No. 63/504,135, filed on May 24, 2023, the content of which is hereby incorporated by reference in its entirety.

### BACKGROUND

Biomass is one category of possible renewable alternatives to petroleum-based fuels, chemicals, and other products. However, it remains challenging to develop efficient, cost effective, and environmentally benign technologies for converting biomass to useful products.

As a promising alternative to petroleum-based fuels and chemicals, bioreforming processes provide liquid fuels and chemicals derived from biomass, such as cellulose, hemicellulose, and lignin found in plant cell walls. For instance, cellulose and hemicellulose can be used as feedstock for various bioreforming processes, including aqueous phase reforming (APR) and hydrodeoxygenation (HDO)—catalytic reforming processes that, when integrated with hydrogenation, can convert cellulose and hemicellulose into hydrogen and hydrocarbons, including liquid fuels and other chemical products. In an APR process, hydrogen is produced from water-soluble oxygenate species at temperatures and pressures lower than those used in conventional steam methane reforming (SMR) technology. For example, an APR process may include contacting water and an oxygenated hydrocarbon (such as ethylene glycol, propylene glycol, glycerol, sorbitol, etc.) with a catalyst in either the liquid or vapor phase. Through a series of reactions, H₂ and CO are produced. Under the APR conditions, the water-gas shift (WGS) equilibrium favors H₂/CO₂ production, and CO+H₂O are converted into H₂ and CO₂. Small amounts of gaseous alkanes (CH₄, C₂H₆, C₃H₈, etc.) and water soluble oxygenates (MeOH, EtOH, acetone, iPrOH, etc.) are also produced.

APR methods are described, for example, in U.S. Pat. Nos. 6,699,457, 6,964,757, 6,964,758, and 7,618,612 (all to Cortright et al., entitled “Low-Temperature Hydrogen Production from Oxygenated Hydrocarbons”) and U.S. Pat. No. 6,953,873 (to Cortright et al., entitled “Low-Temperature Hydrocarbon Production from Oxygenated Hydrocarbons”), all of which are incorporated herein in their entireties by reference. However, current APR technologies employ broad ranges of operating conditions, such as an APR temperature of not greater than 400° C. (U.S. Pat. No. 6,699,457) or 100° C.-450° C. (U.S. Pat. No. 6,953,873) with no firm indication for pressure range other than a pressure to maintain a reactant (water or oxygenated hydrocarbon) liquid or gaseous. Many reported APR technology developments either attempt to understand the catalyst and/or mechanism of the APR process or focus on optimizing catalyst formulations to achieve higher turnover frequencies per catalyst site (TOFs). There remains a need for selected process parameters that systematically improve the APR technology to achieve higher H₂ yields and overall efficiency.

### SUMMARY OF THE INVENTION

Described herein are reactor systems and methods for producing hydrogen by aqueous phase reforming (APR) reaction under improved conditions.

In one aspect, the present disclosure provides a method of producing hydrogen comprising providing a feed stream comprising water and about 25% to about 50% by weight a water-soluble oxygenated hydrocarbon having at least two carbon atoms; reacting the feed stream at a temperature of about 250° C. to about 350° C., at a pressure of about 250 psig to about 700 psig, and in the presence of a catalyst comprising a metal and a support, whereby hydrogen is produced; and providing a product stream including the produced hydrogen. In some embodiments, the method further comprises reacting the feed stream at a weight hourly space velocity (WHSV) of about 1 hr⁻¹ to about 5 hr⁻¹.

In some embodiments, the water-soluble oxygenated hydrocarbon comprises glycerol. In some embodiments, the metal comprises a transition metal selected from the group consisting of Ni, Pd, Pt, Ru, Rh, Ir, an alloy thereof, and a combination thereof. Optionally, the transition metal can be alloyed or admixed with an additional metal selected from the group consisting of Cu, Zn, Re, an alloy thereof, and a combination thereof. The support can be a powder or an extruded solid. In some embodiments the support comprises activated carbon (e.g., in powder or granular form).

### BRIEF DESCRIPTION OF DRAWINGS

FIG. 1 shows a schematic diagram of a representative, non-limiting reactor system for carrying out the present method of producing hydrogen, for example, via condensed liquid phase reforming of oxygenated hydrocarbons.

FIG. 2 shows response optimization results generated by Minitab statistical software using data from APR reaction conditions screening tests.

FIG. 3 shows conversion to gas (%) and H₂ yield (%) for APR system under the reaction conditions identified herein: 5 wt % Pt Pt:Re_{0.5} on Calgon 208C granular carbon, 30 wt % glycerol, 310 psig, 305° C., WHSV=1.5 hr⁻¹, reactor OD=1″.

FIG. 4 shows conversion to gas (%) and H₂ yield (%) for APR system under the reaction conditions identified herein: 5 wt % Pt Pt:Re_{0.5} on Calgon 208C granular carbon, 30 wt % glycerol, 310 psig, 305° C., WHSV=1.5 hr⁻¹, reactor OD=1″. The temperature was increased from 305° C. to 325° C.

### DETAILED DESCRIPTION OF THE INVENTION

The present disclosure relates to reactor systems and methods for improving hydrogen yield in aqueous phase reforming (APR) reactions. In various embodiments, catalysts and operation parameters of the reactions are selected to achieve remarkably and unexpectedly improved hydrogen yield and overall efficiency. The unique combination of reaction conditions described herein thus provides unexpected advantage and higher yield over the conventional processes.

As described herein, the “APR reaction” or the “reaction” can take place in the vapor phase, in the same fashion as conventional steam reforming reactions (although generally at a much lower temperature). The reaction can also take place in the condensed liquid phase, in which case the reactants (water and an oxygenated hydrocarbon) remain condensed liquids, as opposed to being vaporized prior to reaction.

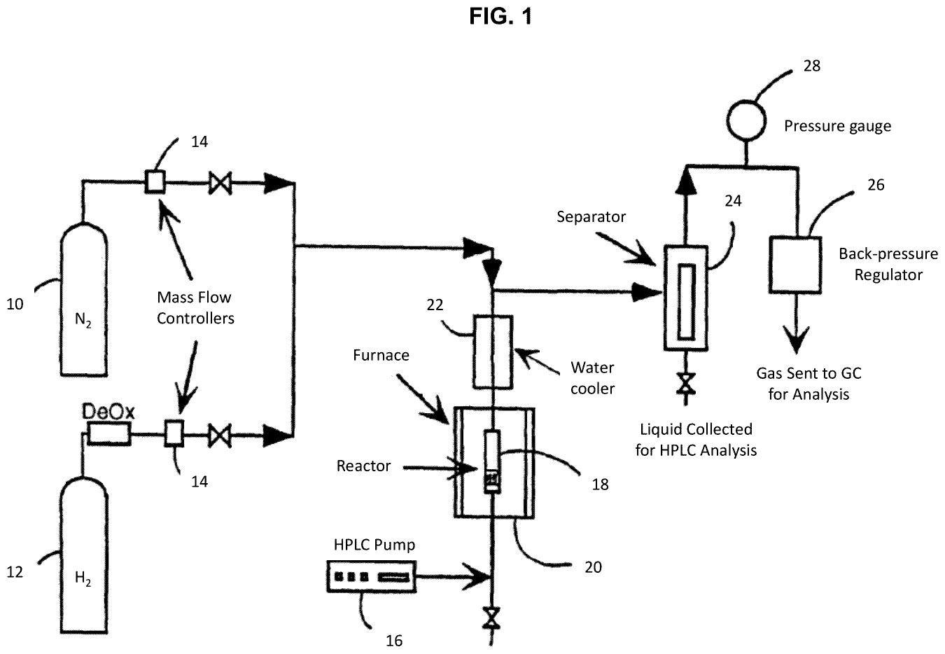

The APR reaction as described herein can be carried out in any suitable reactor system, including those disclosed in U.S. Patent. No. U.S. Pat. No. 6,699,457, which is incorporated herein by reference in its entirety. A representative, non-limiting reactor system for carrying out the present methods is depicted in FIG. 1. It is understood that many other reactor configurations can be utilized with equal success. As shown in FIG. 1, a reactor 18 is disposed within a furnace 20. Liquid reactants can be introduced into the reactor 18 as s a feed stream via pump 16 (e.g., an HPLC pump). Nitrogen supply 10 and hydrogen supply 12 are provided to maintain the overall pressure of the system and the partial pressure of hydrogen within the system chambers in and downstream of the reactor 18. Mass flow controllers 14 are provided to regulate the introduction of nitrogen and hydrogen into the system.

A heat exchanger 22 is provided to reduce the temperature of the products exiting the reactor 18. As shown in FIG. 1, the heat exchanger is a water cooler, but any type of heat exchanger will suffice. The products are then swept into separator 24. The design of the separator is not critical to the function of the invention, so long as it functions to separate gaseous products from liquid products. Many suitable separators to accomplish this function are known in the art, including distillation columns, packed columns, selectively-permeable membranes, and the like. Pressure regulator 28 and back-pressure regulator 26 serve to monitor and maintain the pressure of the system within the set value or range.

In a representative, non-limiting condensed liquid phase reforming reaction according to the present disclosure, a suitable metal-containing catalyst, preferably a metal catalyst impregnated on a support (such as carbon), is placed into the reactor 18. The metal catalyst is then reduced by flowing hydrogen from 12 into the reactor at a suitable temperature (e.g., approximately 350° C.). The pressure of the system is then increased to a suitable pressure (about 300 psig) using nitrogen from 10. The pump 16 is then used to fill the reactor 18 with an aqueous solution of reactant oxygenated hydrocarbon (e.g., glycerol).

The liquid effluent from the reactor is then cooled in the heat exchanger 22 and combined with nitrogen flowing at the top of the separator. The gas/liquid effluent is then separated at 24. The product gas stream can then be analyzed by any number of means (e.g., gas chromatography for in-line analysis). Similarly, the effluent liquid may also be drained and analyzed. Advantageously, the present reaction can be performed in a single reactor system to yield a product comprised almost entirely of H₂, CO₂, and H₂O. The products can be then swept into a separator (such as a membrane separator or pressure swing absorption system) where the hydrogen is separated from the CO₂ and the water. The hydrogen so produced can be used for any purpose where hydrogen is needed.

The reactions of the present disclosure can be carried out in a non-limiting process that includes: loading a metallic catalyst into a reactor and reducing the metal (if necessary), subsequently introducing an aqueous solution of the oxygenated hydrocarbon into the reactor, and reforming the solution in the presence of the catalyst. The pressure within the reactor can be kept sufficiently high to maintain the water and oxygenated hydrocarbon in the condensed liquid phase at the selected temperature. An intermediate product, CO, can be produced and subsequently converted to additional hydrogen and carbon dioxide via a water-gas shift reaction (WGS, represented by CO+H₂O→CO₂+H₂), a reaction that can occur within the same reactor. It is also possible that the catalyst may convert the reactant to CO₂ and H₂ without passing through a CO intermediate. The vapor-phase reforming process can proceed in essentially the same fashion, provided that the reactants are allowed to vaporize and the reaction takes place in the gas phase, rather than in the condensed liquid phase.

In one aspect, the present disclosure provides a method of producing hydrogen comprising: providing a feed stream comprising water and 25% to 50% by weight a water-soluble oxygenated hydrocarbon having at least two carbon atoms; reacting the feed stream at a temperature of 250° C. to 350° C., at a pressure of 250 psig to 700 psig, and in the presence of a catalyst comprising a metal and a support, whereby hydrogen is produced; and providing a product stream including the produced hydrogen.

### Oxygenated Hydrocarbons and Feed Stream

Suitable oxygenated hydrocarbons include those that are water-soluble and have at least two carbons. In some embodiments, the oxygenated hydrocarbon has from 2 to 12 carbon atoms. In some embodiments, the oxygenated hydrocarbon has from 2 to 6 carbon atoms. In some embodiments, the oxygenated hydrocarbon has a carbon-to-oxygen ratio of 1:1, regardless of the number of carbon atoms in the oxygenated hydrocarbon.

In some embodiments, the oxygenated hydrocarbon is a water-soluble oxygenated hydrocarbon selected from the group consisting of ethanediol, ethanedione, glycerol, glyceraldehyde, aldotetroses, aldopentoses, aldohexoses, ketotetroses, ketopentoses, ketohexoses, alditols, and a combination thereof. In some embodiments, the carbon oxygenated hydrocarbon is a C₃, C₄, C₅, or C₆ hydrocarbon (having 3, 4, 5, or 6 carbon atoms, respectively), or a combination thereof. Suitable C₆ oxygenated hydrocarbons include, for example, aldohexoses and corresponding alditols, such as glucose and sorbitol. Suitable oxygenated hydrocarbons having more than 6 carbon atoms include, for example, sucrose and oligosaccharides. In some embodiments, the oxygenated hydrocarbon includes smaller compounds, such as ethanediol, glycerol, glyceraldehyde, or a combination thereof.

Vapor phase reforming requires that the oxygenated hydrocarbon reactants have a sufficiently high vapor pressure at the reaction temperature so that the reactants are in the vapor phase. In particular, suitable oxygenated hydrocarbon compounds for vapor phase method of the present disclosure include, but are not limited to, ethanediol, glycerol, glyceraldehyde, and a combination thereof. Where the reaction is to take place in the liquid phase, suitable oxygenated hydrocarbons include, for example, glycerol, glucose, sorbitol, sucrose, and a combination thereof.

In some embodiments, the oxygenated hydrocarbon comprises glycerol. The oxygenated hydrocarbon can include at least 50% glycerol by weight, including but not limited to at least 55%, at least 60%, at least 65%, at least 70%, at least 75%, at least 80%, at least 85%, at least 90%, and at least 95% glycerol by weight.

In the present methods the feed stream can be prepared, for example, by mixing the oxygenated hydrocarbon compound and water to form an aqueous solution. The feed stream can comprise at least 25% by weight a water-soluble oxygenated hydrocarbon, including by not limited to at least 29%, at least 35%, at least 40%, and at least 45% by weight. The feed stream can comprise at most 50% by weight a water-soluble oxygenated hydrocarbon, including by not limited to at most 45%, at most 40%, at most 37%, and at most 30% by weight. In some embodiments, the feed stream comprises about 29% to about 40% by weight the water-soluble oxygenated hydrocarbon. In some embodiments, the feed stream comprises about 29% to about 37% by weight the water-soluble oxygenated hydrocarbon. For example, the feed stream comprises about 29%, about 30%, about 32%, about 35%, or about 38% by weight the water-soluble oxygenated hydrocarbon. In some embodiments, the water-soluble oxygenated hydrocarbon is glycerol, and the feed stream comprises about 30% by weight glycerol.

In some embodiments, the feed stream comprising water and the oxygenated hydrocarbon has a pH of from about 3.0 to about 10.0, such as about 3.0 to about 8.0, about 3.0 to about 7.0, about 4.0 to about 8.0, or about 4.0 to about 7.0.

In some embodiments, the present method comprises reacting the feed stream at a weight hourly space velocity (WHSV) of about 1 hr⁻¹ to about 5 hr⁻¹. The velocity can be, for example, a measurement of the amount of feed stream introduced into the reactor, where the feed stream contact with the catalyst, per unit time. The velocity can be expressed as, for example, weight of oxygenated hydrocarbon (gram) per weight of catalyst (gram-1) per time (hour-1), or in short hr⁻¹. In some embodiments, the weight hourly space velocity can be about 1 hr⁻¹ to about 4.5 hr⁻¹, about 1 hr⁻¹ to about 4 hr⁻¹, about 1 hr⁻¹ to about 3.5 hr⁻¹, about 1 hr⁻¹ to about 3 hr⁻¹, about 1 hr⁻¹ to about 2.5 hr⁻¹, or about 1 hr⁻¹ to about 2 hr⁻¹. In some embodiments, the weight hourly space velocity is about 1 hr⁻¹ to about 3.5 hr⁻¹ or about 1 hr⁻¹ to about 2.5 hr⁻¹. In some embodiments, the weight hourly space velocity is about 1.5 hr⁻¹, about 2 hr⁻¹, about 2.5 hr⁻¹, about 3 hr⁻¹, or about 3.5 hr⁻¹.

### Catalysts

The present catalyst can comprise a metal and a support material. The catalysts as described herein can include known catalyst systems utilized in APR reactions. Suitable catalysts include those metallic catalysts capable of cleaving the C—C bonds of a given oxygenated hydrocarbon compound faster than the C—O bonds of that compound under the chosen reaction conditions. Suitably, the metallic catalyst can have minimal activity toward the cleavage of C—O bonds. Use of a catalyst system having high activity for C—O bond cleavage can result in the formation of undesired by-products, such as alkanes.

Suitably, the metal can adhere to the support material. The metal of the present catalyst can comprise one or more transitional metals, such as nickel (Ni), palladium (Pd), platinum (Pt), ruthenium (Ru), rhodium (Rh), iridium (Ir), an alloy thereof, and a combination thereof. The transition metal may be alloyed or admixed with an additional metal selected from the group consisting of Group IB metals, Group IIB metals, and Group VII metals. The additional metal can be, for example, copper (Cu), zinc (Zn), rhenium (Re), cobalt (Co), manganese (Mn), an alloy thereof, or a combination thereof. In some embodiments, the amount of the additional metal is less than 70% of the weight of the one or more transition metals in the present catalyst, including less than 60%, less than 50%, or less than 40%.

In some embodiments, the metal of the present catalyst comprises platinum and rhenium. For example, the ratio of the platinum and rhenium metals can be 1:0.5, which can be also referred to as PtRe_{0.5}.

The support can provide a stable platform for the chosen catalyst and the reaction conditions. Suitable supports include, but are not limited to, silica, alumina, zirconia, titania, ceria, carbon, silica-alumina, silica nitride, and boron nitride. Furthermore, nanoporous supports such as zeolites, carbon nanotubes, or carbon fullerene may be utilized. The support can be a powder or an extruded solid. In some embodiments, the support comprises activated carbon, such as activated carbon in powder or granular forms. Suitable support includes commercial products, such as Calgon 208C granular activated carbon (Calgon Carbon Corp., PA).

In some embodiments, the metal is present in an amount of about 0.25% to about 50% by total weight of the catalyst system (the weight of the support being included), such as from about 0.5% to about 30%, from about 1% to about 30%, from about 1% to about 20%, from about 1% to about 10%, or from about 1% to about 5% by total weight. In some embodiments, the metal is present in an amount of about 1%, about 5%, or about 10% by total weight of the catalyst system. In some embodiments, the metal is present in an amount of about 7.5% by total weight of the catalyst system.

Useful catalyst systems for the present method include, but are not limited to: ruthenium supported on silica, palladium supported on silica, iridium supported on silica, platinum supported on silica, rhodium supported on silica, cobalt supported on silica, nickel supported on silica, iron supported on silica, nickel-palladium supported on silica, nickel-platinum supported on silica, ruthenium-palladium supported on silica, and platinum supported on carbon. The metals of these catalysts may be further alloyed or admixed with copper, zinc, and/or rhenium. In some embodiments, the catalysts comprises platinum supported on carbon (Pt/C) or platinum-rhenium supported on carbon (Pt—Re/C).

The catalyst system useful in the reforming reaction of a specific oxygenated hydrocarbon compound may vary, and can be chosen based on factors such as overall yield of hydrogen, length of activity, and expense. The catalyst systems as described herein can be prepared by conventional methods, including for example, evaporative impregnation techniques, incipient wetting techniques, chemical vapor deposition, magnetron sputtering techniques, and the like. The method chosen to fabricate the catalyst is not particularly critical to the function of the catalyst. Different catalysts may yield different results, depending upon considerations such as overall surface area, porosity, etc.

### Temperature and Pressure

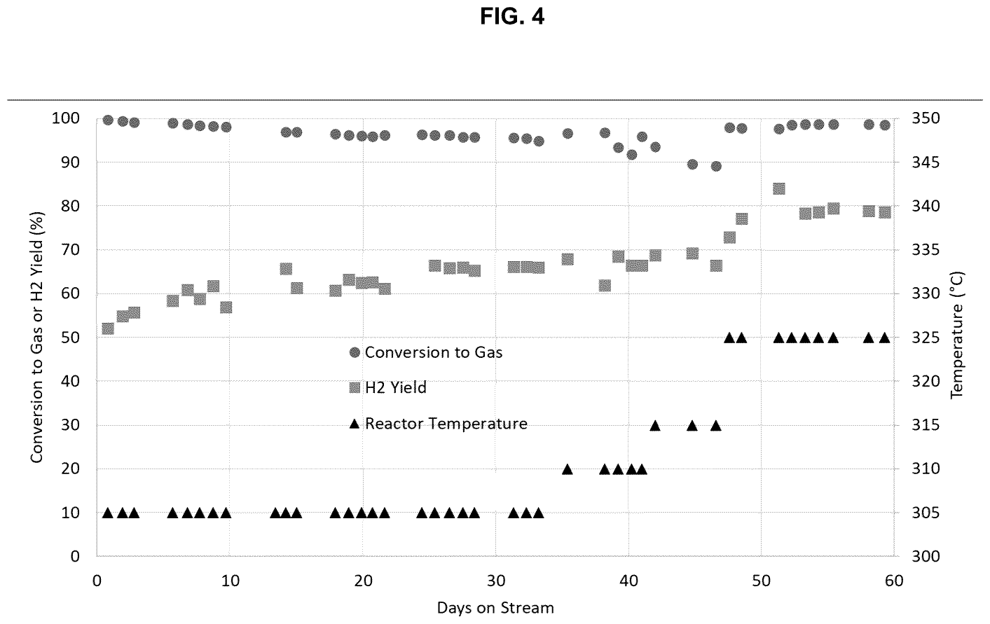

The present method can be carried out at a temperature at which the hydrogen production reaction is facile. In some embodiments, the temperature of the present method is about 250° C. to about 350° C., about 250° C. to about 340° C., about 255° C. to about 340° C., about 260° C. to about 340° C., about 265° C. to about 340° C., about 270° C. to about 340° C., about 275° C. to about 340° C., about 275° C. to about 330° C., or about 275° C. to about 320° C. In some embodiments, the temperature is about 260° C. to about 340° C., about 275° C. to about 340° C., or about 305° C. to about 325° C. For example, the temperature can be about 275° C., about 280° C., about 285° C., about 290° C., about 295° C., about 300° C., about 305° C., about 310° C., about 315° C., about 320° C., about 325° C., about 330° C., about 335° C., about 340° C., about 345° C., or about 350° C. In some embodiments, the temperature is about 305° C. In some cases, the temperature for reacting the feed stream may be adjusted within a temperature range during the operation of the present method. For example, the method further may comprise adjusting the temperature from a first temperature to a second temperature. In some embodiments, the second temperature is higher than the first temperature. In some embodiments, the first temperature is higher than the second temperature. Changing from the first temperature to the second temperature may be associated with changes in hydrogen yield and/or gas conversion rate, such as the increases observed in Example 2 and shown in FIG. 4. The first temperature may be maintained for a first temperature time duration and, similarly, the second temperature may be maintained for a second temperature time duration. In some cases, the first temperature time duration may be about 1 hour to about 35 days or longer, such as about 6 hours, about 12 hours, about 1 day, about 5 days, about 10 days, about 20 days, or about 30 days. In some cases, the second time duration may be about 1 hours to about 35 days or longer, such as about 6 hours, about 12 hours, about 1 day, about 5 days, about 10 days, about 20 days, or about 30 days.

The pressure selected for the reactions may vary with the temperature. For condensed phase liquid reactions, the pressure within the reactor is sufficient to maintain the reactants in the condensed liquid phase. Surprisingly, the present method achieves high hydrogen yield (e.g., at least 40%) at a significantly reduced pressure compared to conventional technology. In some embodiments, the pressure of the present method is about 250 psig to about 650 psig, about 250 psig to about 600 psig, about 250 psig to about 500 psig, about 250 psig to about 400 psig, about 275 psig to about 650 psig, about 275 psig to about 600 psig, about 275 psig to about 500 psig, or about 275 psig to about 400 psig. In some embodiments, the pressure of the present method is about 275 psig to about 650 psig or about 275 psig to about 400 psig. For example, the pressure can be about 280 psig, about 290 psig, about 300 psig, about 310 psig, about 320 psig, about 330 psig, about 340 psig, about 350 psig, about 360 psig, about 370 psig, about 380 psig, about 390 psig, or about 400 psig. In some embodiments, the pressure is about 310 psig.

In some embodiments, the feed stream comprises about 30% by weight glycerol, the catalyst comprises Pt, Re, and activated carbon, the temperature is about 305° C., the pressure is about 310 psig, and the weight hourly space velocity is about 1.5 hr⁻¹.

### Performance

The performance of the catalytic process as described herein can be measured by, for example, hydrogen (H₂) yield and gas conversion rate. H₂ yield is a calculation of the amount of H₂ produced relative to the theoretical limit. For example, for glycerol, the theoretical maximum is 7 mols H₂ produced per mol of glycerol (C₃H₈O₃+3H₂O>3CO₂+7H₂). Gas conversion rate is a measurement of the amount of carbon that is converted into gaseous products, such as CO, CO₂, CH₄, C₂H₆, C₃H₈, etc. Typically, lower conversion to gas efficiency occurs before significant H₂ yield losses. As such, gas conversion rate is an important leading metric for system performance. The gas conversion rate can be calculated by taking the flow rate of carbon-containing gases out of the reactor (e.g., in units of g carbon/minute) and dividing it by the flow of carbon into the reactor (e.g. g carbon/minute). For example, a sample of the aqueous effluent from the catalytic process can be taken and the total organic carbon (TOC) in the sample can be analyzed to determine the carbon content of the aqueous effluent by difference.

In some embodiments, the catalyst displays stable activity for a period of at least 10 days under the reaction conditions of the present method. As used herein, the “stable activity” or “stability” refers to a catalyst's capacity to maintain at least 80% of its catalytic activity (e.g., as measured by hydrogen yield or gas conversion rate) as a fresh catalyst. A “fresh” catalyst means a newly prepared catalyst that has not been exposed to reaction with a feed stream as disclosed herein. For example, the catalyst displays stable activity for a period of at least 15 days, at least 20 days, at least 25 days, at least 30 days, at least 35 days, at least 40 days, at least 45 days, or at least 50 days.

In some embodiments, in the present catalytic process, a gas conversion rate of at least 80% is maintained during the period in which the catalyst displays stable activity. For example, a gas conversion rate of at least 85%, at least 90%, at least 92%, at least 94%, at least 96%, at least 98%, or at least 99% is maintained during the period. In some embodiments, the gas conversion rate is maintained at a level of at least 90% during the period.

In some embodiments, in the present catalytic process, a hydrogen yield of at least 30% is maintained during the period in which the catalyst displays stable activity. For example, a hydrogen yield of at least 35%, at least 40%, at least 45%, at least 50%, at least 55%, at least 60%, at least 65%, at least 70%, at least 75%, at least 80%, or at least 85% is maintained during the period. In some embodiments, the hydrogen yield is maintained at a level of at least 40% during the period.

In some embodiments, in the present catalytic process, the catalyst displays stable activity for a period of at least 20 days, during which a hydrogen yield of at least 50% is maintained.

In some embodiments, in the present catalytic process, the catalyst displays stable activity for a period of at least 40 days, during which a hydrogen yield of at least 55% is maintained.

Unless defined otherwise, all technical and scientific terms used herein have the same meaning as commonly understood by one of ordinary skill in the art to which the invention pertains. All definitions, as defined and used herein, should be understood to control over dictionary definitions, definitions in documents incorporated by reference, and/or ordinary meanings of the defined terms.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter. As used herein, the singular forms “a”, “an”, and “the” include plural embodiments unless the context clearly dictates otherwise. The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

The present invention has been described in terms of one or more preferred embodiments, and it should be appreciated that many equivalents, alternatives, variations, and modifications, aside from those expressly stated, are possible and within the scope of the invention.

### EXAMPLES

### Example 1

In a study to improve H₂ yields for the APR process, a pressure survey was performed under otherwise constant conditions. At a heater temperature of 260° C., a glycerol concentration of 36 wt %, a WHSV of 1 hr⁻¹, and using a 5 wt % Pt Pt:Re_{0.5} on Calgon 208C granular carbon (80×120 mesh) catalyst, the reactor pressure was tested from 400-700 psig. A significant improvement was observed from the baseline pressure of 625 psig, which displayed an H₂ yield of 44%, to a lower pressure of 400 psig, which had an H₂ yield of 51%. Surprisingly, these results were inconsistent with prior observations of a decrease in H₂ yields when going from 600 psig to 150 psig with a reactor temperature of 270° C., a WHSV of 1.5 hr⁻¹, 50 wt % glycerin, and a 5% Pt Pt:Re_{0.5} on Calgon 206P catalyst.

Based on these new results, further studies were conducted to improve various reaction conditions: reactor pressure (° C.), reactor temperature (psig), glycerol concentration (wt %), and WHSV (hr⁻¹). Minitab statistical software was used to generate a central composite response surface design with the four contiguous factors. A total of 7 center points were used with 1 block, resulting in 31 conditions tested. Two additional tests were added with the baseline conditions (260° C., 625 psig, 36.7 wt % glycerol, WHSV=1 hr⁻¹) to check for catalyst deactivation during the experiment. The limits for the four variables are shown in Table 1. The full run plan is shown in Table 2. These standard conditions achieved 40-45% H₂ Yield.

TABLE 1
Four variables and low/high settings for screening

| Factor | Low | High |
|---|---|---|
| WHSV (hr⁻¹) | 1 | 1.75 |
| Temperature (° C.) | 260 | 290 |
| Pressure (psig) | 425 | 650 |
| Glycerol Concentration (wt %) | 30 | 40 |

TABLE 2
Full run plan and results

| | Temperature | Pressure | Glycerol | H2 Yield | Conversion |
|---|---|---|---|---|---|
| WHSV | (° C.) | (psig) | (wt %) | (%) | to Gas (%) |
| 1.375 | 275 | 537.5 | 36.7 | 50.7 | 93.1 |
| 1.375 | 275 | 537.5 | 36.7 | 51.0 | 93.1 |
| 1.375 | 260 | 537.5 | 36.7 | 50.6 | 92.5 |
| 1.375 | 260 | 312.5 | 36.7 | 50.4 | 89.6 |
| 1.375 | 275 | 312.5 | 36.7 | 51.3 | 89.9 |
| 0.625 | 275 | 312.5 | 36.7 | 38.5 | 92.9 |
| 1.375 | 305 | 537.5 | 36.7 | 47.4 | 93.6 |
| 1.375 | 275 | 537.5 | 36.7 | 49.4 | 93.2 |
| 1.375 | 275 | 537.5 | 36.7 | 49.4 | 92.5 |
| 2.125 | 275 | 537.5 | 36.7 | 49.4 | 91.4 |
| 1.375 | 275 | 537.5 | 36.7 | 49.9 | 92.1 |
| 1.375 | 275 | 762.5 | 36.7 | 47.3 | 93.0 |
| 3.45 | 245 | 537.5 | 36.7 | 14.0 | 86.9 |
| 1 | 260 | 625 | 36.7 | 45.3 | 89.3 |
| 1.375 | 275 | 537.5 | 25.4 | 52.5 | 87.6 |
| 1 | 260 | 650 | 42 | 41.2 | 91.6 |
| 1 | 260 | 425 | 42 | 43.8 | 89.1 |
| 1.75 | 260 | 425 | 42 | 33.5 | 61.0 |
| 1.75 | 290 | 425 | 42 | 45.7 | 86.1 |
| 1 | 290 | 425 | 42 | 43.0 | 95.4 |
| 1 | 290 | 650 | 42 | 43.5 | 95.5 |
| 1.75 | 290 | 650 | 42 | 43.9 | 93.0 |
| 1.75 | 260 | 650 | 42 | 33.1 | 65.7 |
| 1.0 | 290 | 425 | 30 | 49.5 | 95.6 |
| 1.75 | 290 | 650 | 30 | 50.8 | 93.7 |
| 1 | 260 | 650 | 30 | 48.7 | 89.9 |
| 1 | 260 | 425 | 30 | 51.2 | 88.4 |
| 1 | 290 | 650 | 30 | 49.1 | 96.0 |
| 1.75 | 290 | 425 | 30 | 51.9 | 92.9 |
| 1.75 | 260 | 425 | 30 | 43.8 | 71.7 |
| 1.75 | 260 | 650 | 30 | 38.8 | 64.4 |
| 1.375 | 275 | 537.5 | 46 | 38.0 | 75.1 |
| 1 | 260 | 625 | 36.7 | 41.4 | 80.4 |

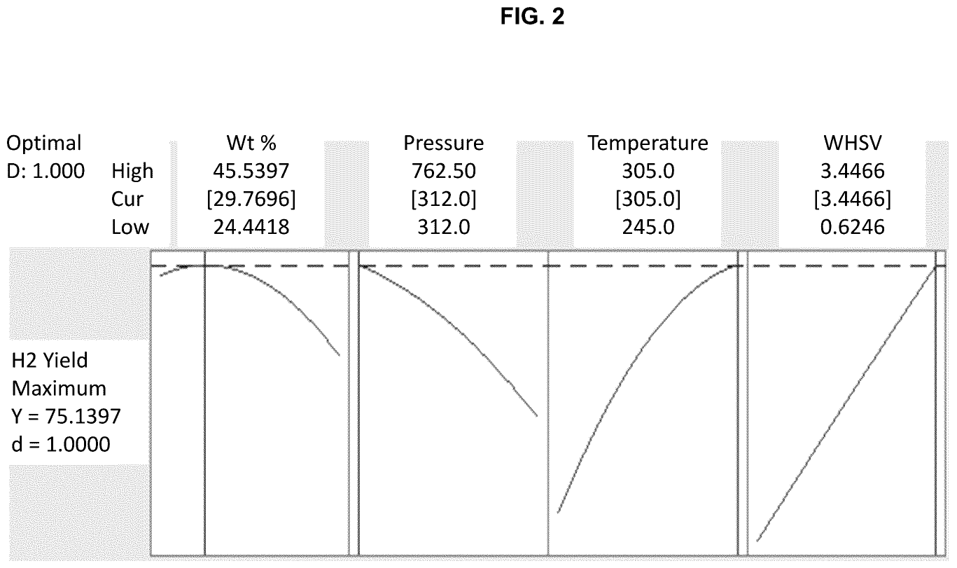

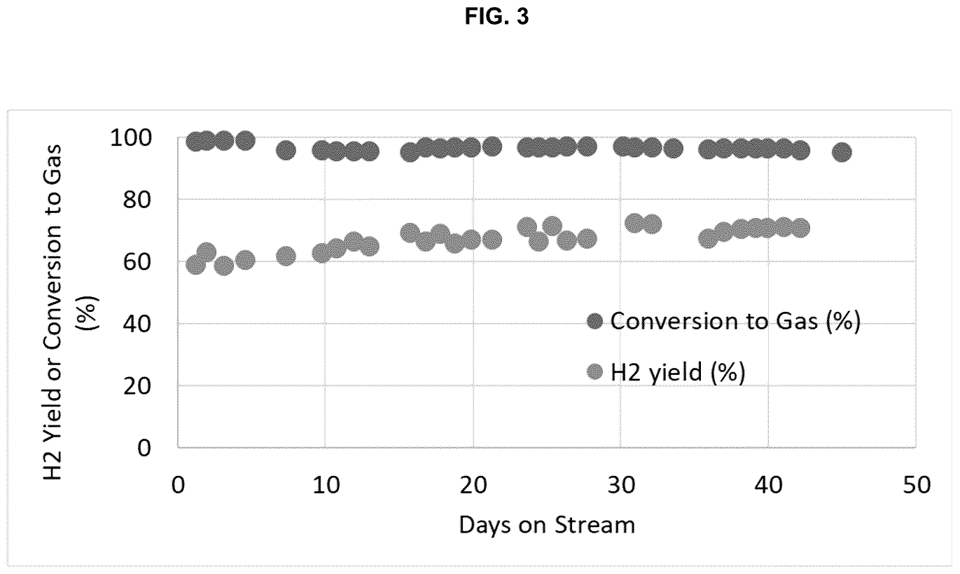

The results from these screening studies were imported into Minitab and analyzed. Optimizing for maximizing the H₂ yield, target conditions of 312 psig. 305° C. 29.8 wt % glycerol. and a WHSV of 3.45 hr⁻¹ were identified (FIG. 2). These conditions were tested in the reactor (using a WHSV of 1.5), and an H₂ yield of >60% and conversion to gas metric >95% were achieved (FIG. 3). Continued operation at these conditions lead to an increase in H₂ Yield to >70% (FIG. 3).

In summary, the studies herein showed significantly enhanced H₂ yields and stability under the conditions of 30 wt % glycerol, 305° C., 310 psig, and a WHSV of 1.5 hr⁻¹. These results were replicated in a second run (with a 1″ OD reactor). The initial H₂ yield at these conditions was around 60%, which increased over the course of ˜2 weeks to >70%. This replicate test illustrates the utility of these identified conditions for achieving high H₂ yields, a vital metric to any commercial success of an APR system.

### Example 2

Using the conditions identified of Example 1 (305° C., 310 psig, WHSV 1.5 hr-1, 30 wt % glycerol). As before, the H₂ yield started around 60% and increased to near 70%. The temperature was increased from 305° C. to 325° C., and an increase in H₂ yields to 80% was observed (FIG. 4). This temperature increase also correlated with an increase in the conversion to gas metric from 90% to 98%.

Although the invention has been described in considerable detail with reference to certain embodiments, one skilled in the art will appreciate that the present invention can be used in alternative embodiments to those described, which have been presented for purposes of illustration and not of limitation. Therefore, the scope of the appended claims should not be limited to the description of the embodiments contained herein.

For reasons of completeness, various aspects of the invention are set out in the following numbered clauses:
Clause 1. A method of producing hydrogen comprising:
providing a feed stream comprising water and about 25% to about 50% by weight a water-soluble oxygenated hydrocarbon having at least two carbon atoms;
reacting the feed stream at a temperature of about 250° C. to about 350° C., at a pressure of about 250 psig to about 700 psig, and in the presence of a catalyst comprising a metal and a support, whereby hydrogen is produced; and
providing a product stream including the produced hydrogen.
Clause 2. The method of clause 1, further comprising reacting the feed stream at a weight hourly space velocity (WHSV) of about 1 hr⁻¹ to about 5 hr⁻¹.
Clause 3. The method of any one of clauses 1-2, wherein the water-soluble oxygenated hydrocarbon comprises glycerol.
Clause 4. The method of any one of clauses 1-3, wherein the metal comprises a transition metal selected from the group consisting of Ni, Pd, Pt, Ru, Rh, Ir, an alloy thereof, and a combination thereof, optionally wherein the transition metal is alloyed or admixed with an additional metal selected from the group consisting of Cu, Zn, Re, Co, Mn, an alloy thereof, and a combination thereof, and wherein the support comprises activated carbon.
Clause 5. The method of any one of clauses 1-4, wherein the metal comprises Pt, and optionally wherein the metal comprises Pt and Re.
Clause 6. The method of any one of clauses 1-5, wherein the metal is present in an amount of about 1% to about 10% by weight of the catalyst.
Clause 7. The method of any one of clauses 1-6, wherein the feed stream comprises about 29% to about 40% by weight the water-soluble oxygenated hydrocarbon.
Clause 8. The method of any one of clauses 1-7, wherein the feed stream comprises about 29% to about 37% by weight the water-soluble oxygenated hydrocarbon.
Clause 9. The method of any one of clauses 1-8, wherein the temperature is about 260° C. to about 340° C.
Clause 10. The method of any one of clauses 1-9, wherein the temperature is about 275° C. to about 340° C.
Clause 11. The method of any one of clauses 1-10, wherein the pressure is about 275 psig to about 650 psig.
Clause 12. The method of any one of clauses 1-11, wherein the pressure is about 275 psig to about 400 psig.
Clause 13. The method of any one of clauses 1-12, wherein the weight hourly space velocity is about 1 hr⁻¹ to about 3.5 hr⁻¹.
Clause 14. The method of any one of clauses 1-13, wherein the weight hourly space velocity is about 1 hr⁻¹ to about 2.5 hr⁻¹.
Clause 15. The method of any one of clauses 1-14, wherein the feed stream comprises about 30% by weight glycerol, the catalyst comprises Pt and activated carbon, the temperature is about 305° C., the pressure is about 310 psig, and the weight hourly space velocity is about 1.5 hr⁻¹.
Clause 16. The method of any one of clauses 1-15, wherein the catalyst displays stable activity for a period of at least 10 days.
Clause 17. The method of clause 16, wherein a gas conversion rate of at least 90% is maintained during the period.
Clause 18. The method of any one of clauses 16-17, wherein a hydrogen yield of at least 40% is maintained during the period.
Clause 19. The method of any one of clauses 1-18, wherein the catalyst displays stable activity for a period of at least 20 days, during which a hydrogen yield of at least 50% is maintained.
Clause 20. The method of any one of clauses 1-19, wherein the catalyst displays stable activity for a period of at least 40 days, during which a hydrogen yield of at least 55% is maintained.
Clause 21. The method of any one of clauses 1-20, further comprising adjusting the temperature from a first temperature to a second temperature.
Clause 22. The method of clause 21, wherein the second temperature is higher than the temperature.

1. A method of producing hydrogen comprising:
providing a feed stream comprising water and about 25% to about 50% by weight a water-soluble oxygenated hydrocarbon having at least two carbon atoms;
reacting the feed stream at a temperature of about 250° C. to about 350° C., at a pressure of about 250 psig to about 700 psig, and in the presence of a catalyst comprising a metal and a support, whereby hydrogen is produced; and
providing a product stream including the produced hydrogen.

2. The method of claim 1, further comprising reacting the feed stream at a weight hourly space velocity (WHSV) of about 1 hr⁻¹ to about 5 hr⁻¹.

3. The method of claim 1, wherein the water-soluble oxygenated hydrocarbon comprises glycerol.

4. The method of claim 1, wherein the metal comprises a transition metal selected from the group consisting of Ni, Pd, Pt, Ru, Rh, Ir, an alloy thereof, and a combination thereof, optionally wherein the transition metal is alloyed or admixed with an additional metal selected from the group consisting of Cu, Zn, Re, Co, Mn, an alloy thereof, and a combination thereof, and wherein the support comprises activated carbon.

5. The method of claim 1, wherein the metal comprises Pt, and optionally wherein the metal comprises Pt and Re.

6. The method of claim 1, wherein the metal is present in an amount of about 1% to about 10% by weight of the catalyst.

7. The method of claim 1, wherein the feed stream comprises about 29% to about 40% by weight the water-soluble oxygenated hydrocarbon.

8. The method of claim 1, wherein the feed stream comprises about 29% to about 37% by weight the water-soluble oxygenated hydrocarbon.

9. The method of claim 1, wherein the temperature is about 260° C. to about 340° C.

10. The method of claim 1, wherein the temperature is about 275° C. to about 340° C.

11. The method of claim 1, wherein the pressure is about 275 psig to about 650 psig.

12. The method of claim 1, wherein the pressure is about 275 psig to about 400 psig.

13. The method of claim 1, wherein the weight hourly space velocity is about 1 hr⁻¹ to about 3.5 hr⁻¹.

14. The method of claim 1, wherein the weight hourly space velocity is about 1 hr⁻¹ to about 2.5 hr⁻¹.

15. The method of claim 1, wherein the feed stream comprises about 30% by weight glycerol, the catalyst comprises Pt and activated carbon, the temperature is about 305° C., the pressure is about 310 psig, and the weight hourly space velocity is about 1.5 hr⁻¹.

16. The method of claim 1, wherein the catalyst displays stable activity for a period of at least 10 days.

17. The method of claim 16, wherein a gas conversion rate of at least 90% is maintained during the period.

18. The method of claim 16, wherein a hydrogen yield of at least 40% is maintained during the period.

19. The method of claim 1, wherein the catalyst displays stable activity for a period of at least 20 days, during which a hydrogen yield of at least 50% is maintained.

20. The method of claim 1, wherein the catalyst displays stable activity for a period of at least 40 days, during which a hydrogen yield of at least 55% is maintained.

21. The method of claim 1, further comprising adjusting the temperature from a first temperature to a second temperature.

22. The method of claim 21, wherein the second temperature is higher than the temperature.
